(19) United States
(12) Patent Application Publication
(10) Pub. No.: US 2003/0182409 A1
(43) Pub. Date: Sep. 25, 2003

(54) Method and system for indicating the progress of device services

(76) Inventor: Mark D. Seaman, Greeley, CO (US)

Correspondence Address: HEWLETT-PACKARD COMPANY, Intellectual Property Administration, P.O Box 272400, Fort Collins, CO, 80527-2400, US

(21) Appl. No.: 10/104,301

(22) Filed: Mar. 22, 2002

(51) Int. Cl. G06F 15/173

(52) U.S. Cl. 709/223

(57) ABSTRACT

A device service progress indication method and system reports the progress of a requested device service in the absence of feedback from the device providing the service to a client device. The method is adaptable and may be applied to a wide variety of open-loop progress indication situations.

### FIELD OF THE INVENTION

The present invention relates generally to intelligent electronic devices and more specifically to methods for indicating the progress of services performed when such devices are in communication with one another.

### BACKGROUND OF THE INVENTION

Intelligent electronic devices such as personal computers, personal digital assistants, and digital cameras frequently interact locally or over a network with other devices such as peripherals or servers. For example, in the familiar client-server model, a client device may request a service such as printing from a second device. If the second device provides feedback regarding the intermediate progress of the requested device service, indicating that progress to the user of the client device is straightforward. If the second device provides no feedback until the requested device service is complete, however, indicating meaningful progress to the user of the client device becomes more difficult.

It is thus apparent that there is a need in the art for an improved method and system for indicating the progress of device services when no feedback from the device providing the service is available.

### SUMMARY OF THE INVENTION

A method for indicating the progress of a device service is provided. Both a system and a computer-readable storage medium containing program code are provided for carrying out the method.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram of an environment in which the invention may operate, in accordance with an illustrative embodiment of the invention.

FIG. 2 is a device service progress dialog box in accordance with an illustrative embodiment of the invention.

FIG. 3 is a method flowchart in accordance with an illustrative embodiment of the invention.

FIG. 4 is an illustration of a system for carrying out the method of the invention in accordance with an illustrative embodiment of the invention.

### DETAILED DESCRIPTION OF THE INVENTION

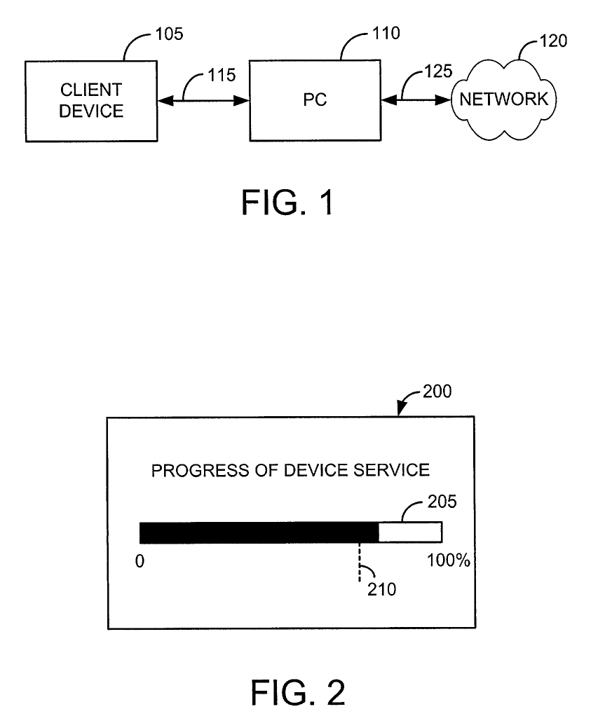

FIG. 1 is a block diagram of an environment in which the invention may operate, in accordance with an illustrative embodiment of the invention. In FIG. 1, client device 105 communicates with personal computer (PC) 110 over communication link 115. PC 110, in turn, may communicate with network 120 over communication link 125. For example, client device 105 may be a digital camera, and personal computer (PC) may communicate with both a local area network (LAN) and the Internet. Client device 105 may request services such as printing, remote archiving of images on an Internet server, the burning of a CD-R on PC 110, or other services via its connection to PC 110. In other embodiments, client device 105 may communicate directly with, for example, the Internet without an intermediate device such as PC 110.

The environment depicted in FIG. 1 is merely one illustrative environment in which the invention may be applied. In general, the invention is applicable to any situation in which a first device requests a service (performance of a task) of a second device, and the second device provides no intermediate feedback indicating progress to the first device until the requested device service is complete. In such situations, the invention may be used to indicate the approximate progress of the requested device service to the user requesting the service. In other words, the invention is applicable to any situation requiring open-loop progress indication.

One manner of indicating the progress of a device service in accordance with an illustrative embodiment of the invention is shown in FIG. 2. In FIG. 2, dialog box 200 contains progress bar 205 to indicate how far a requested device service has progressed. Since no intermediate feedback from the device performing the service is available to client device 105, the reporting of progress may be facilitated as follows. First, a stored estimate of the time required to complete the requested service is recalled. Secondly, elapsed time is measured from when the device service was requested, and progress may be indicated as the elapsed time relative to the estimated completion time. For example, the elapsed time may be shown on progress bar 205 as a percentage of the estimated completion time. Thirdly, whenever the progress exceeds a predetermined threshold 210, the estimate itself may be increased to allow for a longer than expected completion time. Threshold 210 may be set high (e.g., above 70 percent) if confidence in the estimate is high. If confidence in the estimate is low, threshold 210 may be set to a lower value (e.g., 30 percent). Threshold 210 essentially divides the growth of progress bar 205 into a linear region and a non-linear region. Finally, once client device 105 has been informed that the requested device service is complete, progress bar 205 may grow to 100 percent. To improve the estimated completion time for the next request, the actual completion time of the latest request and one or more previous estimates may be averaged in some fashion.

After sufficient repetitions, the estimate converges to a good approximation. The very first time a particular device service is requested, a conservative estimate may be chosen to avoid disappointing the user.

The approach just described has several advantages. First, it is adaptable to the time required for a particular device service. Secondly, progress bar 205 will always show an increasing amount of progress (will not back up) if the estimated completion time is incremented at a rate less than or equal to the rate at which elapsed time is incremented. Finally, incrementing the estimated completion time when progress exceeds threshold 210 allows indication of the progress to be stretched indefinitely.

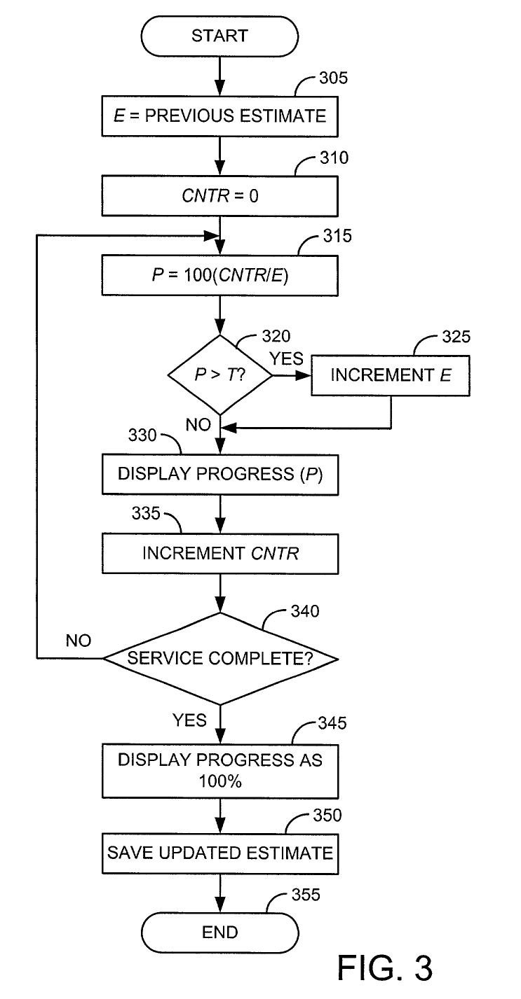

FIG. 3 is a method flowchart in accordance with an illustrative embodiment of the invention. The flowchart of FIG. 3 is entered in response to a request for a device service issued from client device 105. At 305, E is set to a stored previous estimated completion time for the applicable device service. At 310, elapsed time counter CNTR is reset. At 315, progress may be computed as CNTR divided by E converted to a percentage. If progress P exceeds threshold 210 at 320, E may be incremented at 325. In practice, a threshold of 70 percent has been found effective. Otherwise, control proceeds to 330, where the progress P computed at 315 may be displayed as progress bar 205. Elapsed time counter CNTR may then be incremented at 335. If client device 105 has not yet received confirmation that the requested device service is complete at 340, control returns to 315. Otherwise, progress bar 205 may grow to 100 percent at 345. At 350, an updated estimate of completion time based on the actual completion time (the value contained in CNTR) is computed and saved. The process then terminates at 355.

Many possible techniques may be used to compute an updated estimate of completion time at 350. Two examples will be offered in this description. First, the estimated and actual completion times may be averaged using a lossy integration process or so-called “exponential forgetting.” That is, the updated estimate Eᵢ following the ith request for the device service may be computed as

$${E}_{i} = \frac{N {E}_{i - 1} + {T}_{A}}{N + 1} ,$$

where T_{A} is the actual elapsed time required to complete the ith request and N is an arbitrary positive integer. In practice, N=5 has been found to provide sufficient damping. Secondly, the updated estimate at 350 may be computed as a moving average of the actual completion time T_{A} and at least one previous estimate:

$${E}_{i} = \frac{{\sum }_{j = 1}^{M - 1} {E}_{i - j} + {T}_{A}}{M} ,$$

where M is the width of the sliding window over which the moving average is computed. M is a positive integer greater than or equal to two.

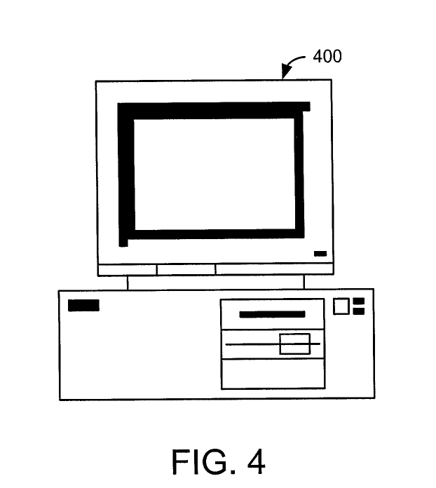

FIG. 4 illustrates a system for carrying out the method of the invention, in accordance with an illustrative embodiment. FIG. 4 depicts a general purpose computer 400. The method of the invention may be programmed to execute on such a general purpose computer 400 or in any other intelligent electronic device such as a digital camera, cellular telephone, notebook computer, palmtop computer, or personal digital assistant (PDA). The invention may be implemented in custom hardware, firmware, or in any combination of hardware or firmware and software. Program code implementing the invention may also be stored on a computer-readable storage medium. Examples of computer-readable storage media include solid-state read-only memory, magnetic disks, and optical disks.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for indicating the progress of a device service, comprising the steps of:
(a) counting the elapsed time from when the device service was requested;
(b) displaying as the progress the elapsed time relative to an estimate of the time required to perform the device service;
(c) incrementing the estimate, when the progress exceeds a predetermined threshold;
(d) repeating steps (b) and (c) until the device service has been completed;
(e) saving an updated estimate of the time required to perform the device service, when the service has been completed.

2. The method of claim 1, wherein the progress comprises the elapsed time as a percentage of the estimate.

3. The method of claim 1, wherein the updated estimate saved in step (e) comprises a first fraction of a previous estimate summed with a second fraction of the elapsed time upon completion of the device service, the first and second fractions adding to one.

4. The method of claim 1, wherein the updated estimate saved in step (e) comprises a moving average of at least one prior estimate and the elapsed time upon completion of the device service.

5. A system programmed to perform the following method:
(a) counting the elapsed time from when a device service was requested;
(b) displaying as the progress of the device service the elapsed time relative to an estimate of the time required to perform the device service;
(c) incrementing the estimate, when the progress exceeds a predetermined threshold;
(d) repeating steps (b) and (c) until the device service has been completed; and
(e) saving an updated estimate of the time required to perform the device service, when the service has been completed.

6. The system of claim 5, wherein the progress comprises the elapsed time as a percentage of the estimate.

7. The system of claim 5, wherein the updated estimate saved in step (e) of the method comprises a first fraction of a previous estimate summed with a second fraction of the elapsed time upon completion of the device service, the first and second fractions adding to one.

8. The system of claim 5, wherein the updated estimate saved in step (e) of the method comprises a moving average of at least one prior estimate and the elapsed time upon completion of the device service.

9. A system for indicating the progress of a device service, comprising:
means for counting the elapsed time from when the device service was requested;
means for calculating the progress as the elapsed time relative to an estimate of the time required to perform the device service;
means for incrementing the estimate, when the progress exceeds a predetermined threshold;
means for displaying the progress; and
means for saving an updated estimate of the time required to perform the device service, when the device service has been completed.

10. The system of claim 9, wherein the progress comprises the elapsed time as a percentage of the estimate.

11. The system of claim 9, wherein the updated estimate comprises a first fraction of a previous estimate summed with a second fraction of the elapsed time upon completion of the device service, the first and second fractions adding to one.

12. The system of claim 9, wherein the updated estimate comprises a moving average of at least one prior estimate and the elapsed time upon completion of the device service.

13. A computer-readable storage medium containing program code to indicate the progress of a device service, comprising:
a first code segment configured to count the elapsed time from when the device service was requested;
a second code segment configured to display as the progress the elapsed time relative to an estimate of the time required to perform the device service;
a third code segment configured to increment the estimate, when the progress exceeds a predetermined threshold, the second and third code segments being repeated until the device service has been completed; and
a fourth code segment configured to save an updated estimate of the time required to perform the device service, when the service has been completed.

14. The computer-readable storage medium of claim 13, wherein the progress comprises the elapsed time as a percentage of the estimate.

15. The computer-readable storage medium of claim 13, wherein the updated estimate saved by the fourth code segment comprises a first fraction of a previous estimate summed with a second fraction of the elapsed time upon completion of the device service, the first and second fractions adding to one.

16. The computer-readable storage medium of claim 13, wherein the updated estimate saved by the fourth code segment comprises a moving average of at least one prior estimate and the elapsed time upon completion of the device service.
